(19) United States
(12) Patent Application Publication
(10) Pub. No.: US 2025/0117234 A1
(43) Pub. Date: Apr. 10, 2025

(54) Personalized Suggestion Manager

(71) Applicant: Google LLC, Mountain View, CA (US)

(72) Inventors: Indu Ramamurthi, Los Altos, CA (US); Ryan Kam Wang Tai, Sunnyvale, CA (US)

(73) Assignee: Google LLC, Mountain View, CA (US)

(21) Appl. No.: 18/903,803

(22) Filed: Oct. 1, 2024

Related U.S. Application Data
(60) Provisional application No. 63/587,805, filed on Oct. 4, 2023.

(51) Int. Cl. G06F 9/451; G10L 15/22; H04L 12/28

(52) U.S. Cl. CPC G06F 9/453; G10L 15/22; H04L 12/282; G10L 2015/223

(57) ABSTRACT

This document describes systems and techniques for implementing personalized suggestions for a user interacting with a facility management system based on contextual metadata to assist the user in controlling the facility management system. For example, a system includes a request module configured to receive a request from a user. A metadata module is configured to access and identify metadata related to a content or context of the request. A large language model (LLM) module is configured to receive the request and the metadata and to generate a suggestion relevant to the content or context of the request. A suggestion module is configured to present the suggestion to the user.

### CROSS-REFERENCE TO RELATED APPLICATION(S)

This application claims priority to U.S. Provisional Patent Application Ser. No. 63/587,805, filed on Oct. 4, 2023, the disclosure of which is incorporated by reference herein in its entirety.

### BACKGROUND

Computing devices are commonly used to search for information. Many types of computing devices enable users to obtain information from these computing devices in response to textual queries, spoken queries, or queries presented in other forms. Computing devices also allow for ever-increasing possibilities for monitoring and control of homes, offices, or other facilities and various devices associated with those facilities. A facility management system may be configured to respond both to user commands or to respond automatically to events according to specified instructions. In seeking information and/or seeking to control a facility management system, users may wish to engage one or more computing devices to present requests related to their homes or offices, nearby areas, and the like.

When users are learning to operate a new facility management system, such as an automated home or office management system, or when users are trying to implement additional functions that may be offered by the system, they may not know how to articulate a request to fully capture what they want. Users may not be able to fully take advantage of the capabilities of the facility management system or they may become frustrated with the facility management system. This type of frustration may discourage a user from engaging with the new system and prevent the user from obtaining the benefits of the system.

### SUMMARY

This document describes systems and techniques for implementing personalized suggestions for a user interacting with a facility management system based on contextual metadata to assist the user in controlling the facility management system. In some aspects, in response to a request from a user, the systems and techniques may analyze metadata associated with the user to determine possible operations the user might want the facility management system to perform. The metadata may be used to identify multiple suggestions to potentially assist the user in accessing and controlling the facility management system.

For example, a system includes a request module configured to receive a request to a facility management system and from a user. A metadata module is configured to access and identify metadata related to a content or context of the request. A large language model (LLM) module is configured to receive the request and the metadata and to generate a suggestion relevant to the content or context of the request. A suggestion module is configured to present the suggestion to the user.

In another example, a system for facility management includes one or more input devices configured to collect data and receive a user request. One or more control devices are configured to respond to instructions based on the user request. A device interface is configured to receive the user request from the one or more input devices. A personalized suggestion manager includes a request module configured to determine that the user requires assistance in submitting the request. A metadata module is configured to access and identify metadata related to a content or context of the request. An LLM module is configured to generate, based on the request and the metadata, a suggestion relevant to the content and or context of the request. A suggestion module is configured to present the suggestion to the user.

In another example, a method includes, responsive to a user presenting a request to a facility management system, accessing metadata associated with a content or context of the request. Metadata related to the content or context of the request is identified. The metadata is presented to an LLM configured to generate a suggestion based on the request and the metadata. The suggestion determined to be relevant to the content or context is received from the LLM. The suggestion is presented to the user.

This document also describes other systems and methods for implementing personalized suggestions for a user. Optional features of one aspect, such as the systems or method described above, may be combined with other aspects.

This summary is provided to introduce simplified concepts for implementing personalized suggestions, which is further described below in the detailed description and drawings. This summary is not intended to identify essential features of the claimed subject matter, nor is it intended for use in determining the scope of the claimed subject matter.

### BRIEF DESCRIPTION OF THE DRAWINGS

The details of one or more aspects of personalized suggestion manager systems and methods are described in this document with reference to the following drawings. The same numbers are used throughout multiple drawings to reference like features and components.

FIG. 1 is a block diagram of a facility management system including an example personalized suggestion manager;

FIG. 2 is a schematic diagram of a facility employing a facility management system including the personalized suggestion manager of FIG. 1;

FIG. 3 is a block diagram of an example metadata module of the personalized suggestion manager of FIG. 1;

FIG. 4 is a block diagram of an example multimodal embedding system of the personalized suggestion manager of FIG. 1;

FIG. 5 is a schematic diagram of an example natural language processing system that may be used with the personalized suggestion manager of FIG. 1;

FIG. 6 is a block diagram of an example suggestion module that may be used with the personalized suggestion manager of FIG. 1;

FIGS. 7A and 7B are schematic diagrams of a computing device in communication with the personalized suggestion manager of FIG. 1 responding to a textual request from a user;

FIGS. 8A-8D, 9A, and 9B are schematic diagrams of the facilities management system with the personalized suggestion manager of FIG. 1 responding to verbal requests from a user;

FIGS. 10A-10C are schematic diagrams of the personalized suggestion manager of FIG. 1 offering assistance to the user in presenting a request;

FIG. 11 is a block diagram of example computers configured to operate as part of the facilities management system with personalized suggestion manager of FIG. 1; and

FIG. 12 is a flow diagram of an example method of providing personalized suggestions in response to a user request.

### DETAILED DESCRIPTION

### Overview

This document describes systems and techniques for implementing personalized suggestions for a user interacting with a facility management system based on contextual metadata to assist the user in controlling the facility management system. The described systems and techniques are useful in a variety of different settings such as home settings, business settings, outdoor settings, and the like.

Various example configurations and methods are described throughout this document. This document now describes example systems and method of the described personalized suggestion management system.

### Example Systems for Providing a Personalized Suggestion Manager

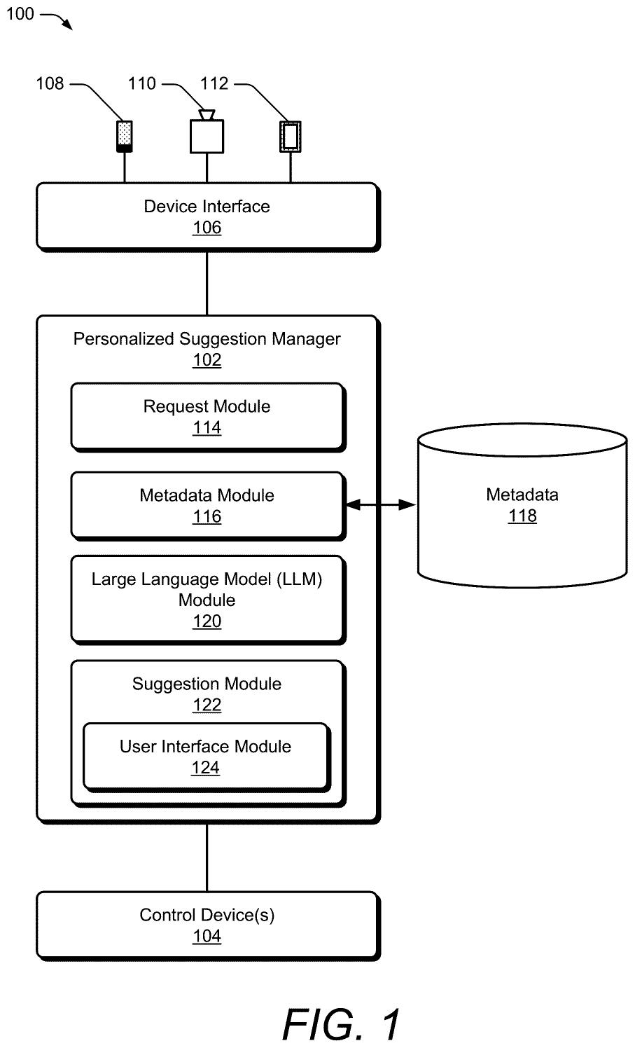

FIG. 1 illustrates a schematic diagram of a facility management system 100 that includes a personalized suggestion manager 102 to assist a user (not shown in FIG. 1) in engaging the facility management system 100 to perform functions to manage the operation of one or more control devices 104 associated with the facility management system 100. As described further below, the control devices 104 may include remotely controllable devices such as lights, appliances, audio output devices, door locks, and other devices in communication with the facility management system 100 that are configured to perform desired functions. A device interface 106 couples one or more input devices to the personalized suggestion manager 102. The input devices may include one or more input devices, such as a smart speaker 108 or another microphone-equipped input device, one or more cameras 110 or other video interfaces, and/or one or more computing devices 112 such as a computer, a panel interface, a tablet interface, a smartphone, or a similar device that may provide video, audio, and/or text input to the facility management system 100. The device interface 106 is configured to receive a request via the one or more input devices 108, 110, and/or 112 from the user and to present the request to the facility management system 100. However, as previously mentioned, the user may not know or may be uncertain what requests they may be able to present or how their request should be presented to direct the facility management system 100 to perform functions that the user may want the one or more control devices 104 of the facility management system 100 to perform.

The personalized suggestion manager 102 may provide assistance to the user in order to present the user with one or more relevant suggestions. The one or more suggestions may include a suggested answer to a question or a suggested course of action to cause the one or more control devices 104 to perform the functions desired by the user. The personalized suggestion manager 102 includes a request module 114 that is configured to receive a request to the facility management system 100 from the user and to determine when the user may require assistance in submitting their request. The request module 114 may be configured to determine when the user may require assistance in a number of ways. The request module 114 may be configured to determine that the user needs assistance based on the user engaging a help function. The request module 114 also may be configured to determine that the user may require assistance because the user delays in presenting the request for longer than a specified interval of time after engaging the request module 114. For example, the user may speak a wake word or engage another input to indicate a desire to make a request, but then more than a specified number of seconds may pass before the user presents the request. For another example, the user may start to present the request but delay in specifying parameters that may be required to fulfill the request, such as by asking to “turn on” one of the control devices 104 without specifying which of the control devices 104 the user wishes to activate.

Similarly, the request module 114 may be configured to determine that the user needs assistance based on the user indicating that a response of the facility management system 100 was unsatisfactory to one or more previous requests. For example, the request module may determine that the response was unsatisfactory if, following the response by the facility management system 100, the user exclaims in the negative, repeats the same request, or immediately utters a very similar request. Also, the request module 114 may be configured to determine that the user needs assistance based on the user having a history of interactions with the facility management system 100 indicative of an inability of the user to secure a desired action. For example, the request module 114 may maintain a history of user requests and may track whether that history reflects the user exclaiming in the negative, repeating the same request, etc., so that the request module 114 may preemptively offer assistance without the user having to request help or for the user to struggle with the current request. The request module 114 may maintain this history information, or that information may be managed by or in concert with a metadata module 116.

The metadata module 116 is configured to access and identify metadata related to a content or context of the request. The metadata module 116 may maintain or be in communication with a store of metadata 118 that may be used in processing the content or context of the request to assist the user in interacting with the facility management system 100. As further described below, the contextual data may include a user's present context, which may include visual and/or audible data receivable via video and/or audio input devices 108, 110, and/or 112 from which the metadata module 116 may access information to ascertain what the user may be requesting. As further described below, objects viewable in visual data and/or sounds included in audio data may reflect what the user may want the facility management system to do. For example, a presence of a particular object in visual data received via the camera 110 may be associated with one or more records stored in the metadata 118. Thus, the metadata module 116 may respond to the presence of the object in the visual data received via the camera 110 to determine what the user may want the facility management system 100 to do. Similarly, a presence of a sound or another audible object detected in audible data received via the smart speaker 108 may be associated with one or more records stored in the metadata 118. Thus, the metadata module 116 may respond to the presence of the audible object in the audio data received via the smart speaker 108 to determine what the user may want the facility management system 100 to do. Also, the metadata 118 may include historical data of previous user requests that the user has presented, which may include requests to which the facility management system 100 satisfactorily responded or failed to satisfactorily respond as signified by indicia such as the user exclaiming in the negative, repeating the same request, etc. In either case, the historical data may be used by the metadata module 116 to determine what function the user may be asking the facility management system 100 to perform.

In aspects, the metadata module 116 works in concert with a large language model (LLM) module 120 and is configured to receive the request and the metadata and to generate one or more suggestions determined to be relevant to the content and/or the context of the request. Based on the metadata module 116 identifying contextual aspects of a user request in combination with content of a user request received from one of the input devices 108, 110, and 112 via the device interface 106, the LLM 120 may generate plain language suggestions representing what it is believed that the request was intended to accomplish. A suggestion module 122 communicates the suggestion to the control devices 104 and/or presents the suggestions to the user via a user interface module 124. In other words, the suggestions may be presented directly to the control devices 104 to the user in the form of actions or operations performed by the control devices 104. Alternatively or additionally, the user interface module 124 may inform the user of the suggestions that are generated. For example, the user interface 124 may present suggestions in audio format via the smart speaker 108 and/or in textual form via a display of the computing device 112.

If one or more of the suggestions represents an action or operation that the user wishes to initiate, the user may then make a selection of one or more of the suggestions via one of the input devices 108 and/or 112 to cause the facility management system 100 to direct one of the control devices 104 to perform the requested function. Thus, the personalized suggestion manager 102 may cause actions or operations to be performed by the control device 104 in response to the content or context of the request. The personalized suggestion manager 102 may also or instead inform the user about what actions or operations may be available based on the content or context of the user's request.

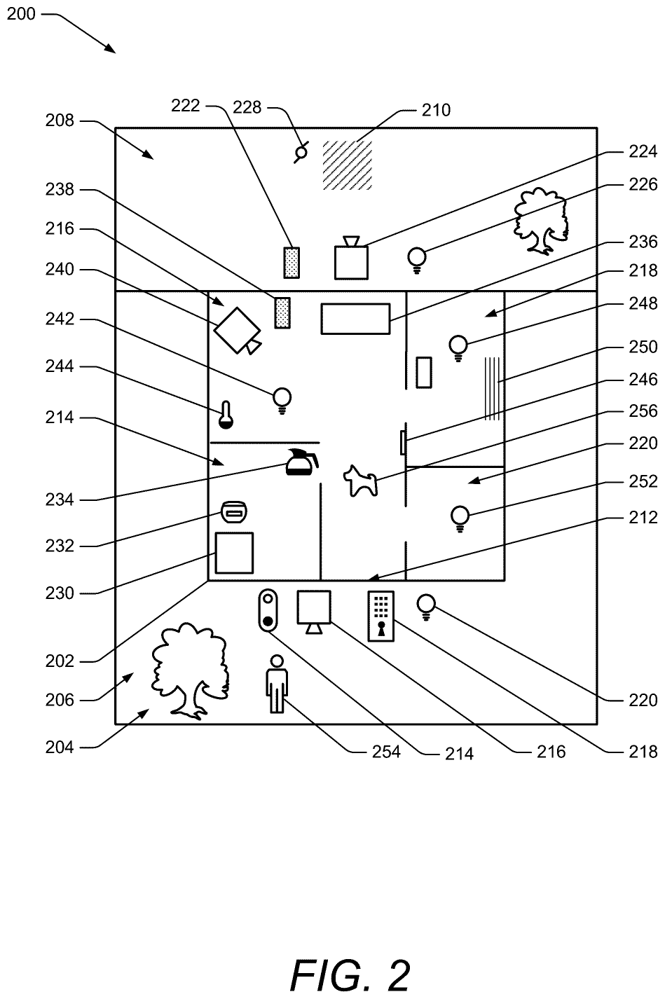

FIG. 2 illustrates a representative facility 200, such as a home or office, with which the facility management system 100 (see FIG. 1) may operate. The foregoing example uses the example of a single-family home, but it will be appreciated that the facility 200 may include a multi-family dwelling or other type of home. Alternatively, the facility 200 may include an office or other business facility. The facility 200 of FIG. 2 includes a house 202 situated on property 204 including a front yard 206 and a backyard 208 that may include a garden 210. The house 202 includes a front entry 212, a kitchen 214, a family room 216, a bedroom 218, and an additional room 220.

The facility 200 may incorporate many devices to monitor and/or control aspects of the facility 200. For example, the front entry 212 may be equipped with a doorbell camera 214, one or more additional cameras 216, an automated lock 218, and a remotely controllable light 220. The backyard 208 may include a smart speaker 222, a camera 224, a remotely controllable light 226, and a controllable sprinkler system 228. The kitchen 214 may include multiple appliances, such as a refrigerator 230, a pressure cooker 232, and a coffee maker 234. The family room 216 may include furniture 236, a smart speaker 238, a camera 240, a remotely controllable light 242, a thermostat 244, and a control panel 246 that enables a user to control the facility management system 100. The bedroom 218 may include a remotely controllable light 248 and a controllable window shade 250. The additional room 220 may include a remotely controllable light 252.

There are a number of spaces and devices in the facility 200 that a user may wish to control and/or monitor with ad hoc requests, based on times or day or other regular stimuli, and based on the appearance or behavior of one or more persons 254, a dog or other pet 256, or other stimuli. It will be appreciated that a modern house may have many more spaces and devices to monitor and/or control than in the simple facility 200 depicted here. The context of a request presented in the facility captured by the smart speakers 222 or 238, the cameras 214, 216, 224, and 240, or other devices associated with the user or the facility 200 associated with the facility management system 100 may include anything that is present or occurs relating to a home, business, yard, activity, device owned, hobby, pet, or individual associated with the user.

With so many devices to monitor and/or control, it may be no wonder that a user may need or appreciate having assistance in determining what control options might be available to them. Merely having a complete list of all available commands and options may be just as overwhelming as the number of spaces and devices to monitor and/or control. Thus, the personalized suggestion manager 102 may provide assistance to the user based on context to provide relevant, helpful assistance to the user, as described below.

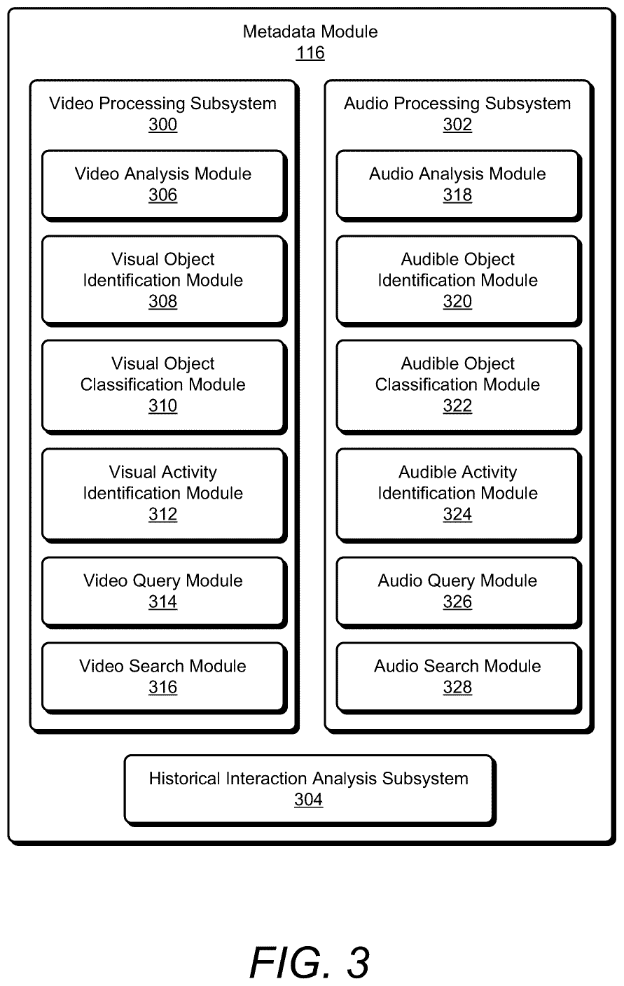

To provide this assistance, the personalized suggestion manager 102 (see FIG. 1) uses the metadata module 116 to analyze cues from the context and/or historical commands to provide suggestions to the user of what types of monitoring or control actions the user may wish to implement. Referring to FIG. 3, in aspects, the metadata module 116 may include a video processing subsystem 300, an audio processing subsystem 302, and/or an historical interaction analysis subsystem 304 to determine what the user may wish to do and to provide suggestions to the user about available actions.

The video processing subsystem 300 may be configured to receive and process images captured by any type of image capture device, such as the cameras 214, 216, 224, and 240 included in the facility 200 (see FIG. 2) or any other still camera or motion video camera. The images may include a single image or a series of images (e.g., image frames) captured during a particular period of time.

In aspects, the video processing subsystem 300 includes a video analysis module 306, a visual identification module 308, a visual object classification module 310, a visual activity identification module 312, a video query module 314, and a video search module 316. The video analysis module 306 may be configured to perform a variety of video analysis operations such as analyzing different types of images to determine image settings, image types, objects in an image, and other factors. In some aspects, the video analysis module 306 may be configured to perform different types of analysis based on the type of image being analyzed. For example, if the image includes one or more people, the video analysis module 306 may be configured to identify and analyze the people in a particular image or in a series of image frames. In other situations, if the image captures an outdoor scene, the video analysis module 306 may be configured to identify and analyze buildings, vehicles, people, trees, and the like contained in the image. The results of the analysis operations performed by the video analysis module 306 may be used by the visual identification module 308, the visual object classification module 310, and other modules and systems discussed herein.

The visual object identification module 308 may be configured to identify various types of objects in one or more images. In some aspects, the visual object identification module 308 may be configured to identify any number of objects and any type of object contained in one or more images. For example, the visual object identification module 308 may be configured to identify people, animals, vehicles, toys, buildings, plants, trees, geological formations, lakes, rivers, airplanes, clouds, and the like. A particular image may include any number of objects and any number of different types of objects. For example, a particular image may include one or more people, one or more animals, one or more cars, a driveway, a street, and/or bushes, trees, or other flora.

The visual object identification module 308 may be configured to identify and record all objects in a particular image for future reference. When recording objects in an image, the visual object identification module 308 may be configured to record (e.g., by storing in any format) data associated with each object, such as the object's location within the image or the object's location with respect to other objects in the image. In other examples, the visual object identification module 308 may be configured to identify and record one or more characteristics of each object, such as the object's type, color, size, orientation, shape, and the like. The results of the identification operations performed by the visual object identification module 308 may be used by the object classification module 310 and other modules and systems discussed herein.

The visual object classification module 310 may be configured to classify multiple types of objects in one or more images. In some aspects, the visual object classification module 310 may use the results of the video analysis module 306 and the visual object identification module 308 to classify each object in an image. For example, the visual object classification module 310 may be configured to use identification data recorded by the visual object identification module 308 to assist in classifying the object. The visual object classification module 310 may also perform additional analysis of the image to further assist in classifying the object.

The classification of an object may include a variety of factors, such as an object type, an object category, an object's characteristics, and the like. For example, a particular object may be identified as a person by the visual object identification module 308. The visual object classification module 310 may further classify the person as male, female, tall, short, young, old, dark hair, light hair, and the like. Other objects may have different classification factors based on the characteristics associated with the particular type of object. The results of the object classification operations performed by the visual object classification module 310 may be used by one or more other modules and systems discussed herein.

As shown in FIG. 3, the video processing subsystem 300 may further include a visual activity identification module 312. The visual activity identification module 312 may be configured to perform a variety of operations related to identifying one or more activities in a particular image. For example, the visual activity identification module 312 may be configured to identify an activity associated with multiple objects in an image. In some aspects, the visual activity identification module 312 may identify that a ball is bouncing in a yard, a person is walking on a sidewalk, a car is moving along a road, a dog is sitting near a pool, and the like.

The type of identified activity determined by the visual activity identification module 312 may depend on the type of object (e.g., based on the object classification performed by the visual object classification module 310). In some situations, a particular object may have multiple identified activities. For example, a person may be running and jumping at the same time or alternating between running and jumping. Information related to the identified activity (or activities) associated with each object may be stored with each object for future reference. The results of the activity identification operations performed by the visual activity identification module 312 may be used by one or more other modules and systems described herein.

The video query module 314 may be configured to analyze queries, such as natural language queries from a user. In some aspects, the queries may request information related to objects or activities in one or more images. For example, a natural language query from a user may request images that show a particular activity, such as, “Who came to the door this morning?” The video query module 314 is configured to analyze the received query to determine the specified object or activity and then analyze videos to identify the images desired by the user. In some implementations, the video query module 314 may use information generated by one or more of the video analysis module 306, the visual object identification module 308, the visual object classification module 310, and the visual activity identification module 312. The results of the query analysis operations performed by the video query module 314 may be used by one or more other modules and systems described herein.

The video search module 316 may be configured to identify various types of objects or activities in one or more images. In some aspects, the video search module 316 may be configured to work in combination with the video query module 314 to identify images that satisfy a user's natural language query. In some implementations, the video search module 316 may use information generated by one or more of the video analysis module 306, the visual object identification module 308, the visual object classification module 310, the visual activity identification module 312, and the video query module 314. The results of the video search operations performed by the video search module 316 may be used by one or more other modules and systems discussed herein.

Correspondingly, the audio processing subsystem 302 may be configured to receive and process audio captured by any type of audio capture device, such as the doorbell camera 214, the one or more audio inputs incorporated in the additional cameras 216 and 224 included in the facility 200 (see FIG. 2) or any other still camera or motion video cameras included in the facility 200, as well as from the smart speakers 222 and 238.

In aspects, the audio processing subsystem 302 includes an audio analysis module 318, an audio identification module 320, an audible object classification module 322, an audible activity identification module 324, an audible activity identification module 324, an audio query module 326, and an audio search module 328. The audio processing subsystem 302 and its components, although configured to work with audio data rather than video data, operate similarly to those of its video processing subsystem 300 counterpart as previously described.

The audio analysis module 318 may be configured to perform a variety of audio analysis operations such as analyzing different types of sounds. The audible object identification module 320 may be configured to identify various types of sounds recorded by the facility management system 200. In some aspects, the audible object identification module 320 may be configured to identify any number of sounds and any type of sound recorded. For example, the audible object identification module 320 may be configured to identify voices, animal sounds, alarm sounds, or other sounds of potential importance, such as running water, breaking glass, and the like. A particular recording may have any number of sounds that may be discerned by the audio object identification module 320.

The audible object identification module 320 may be configured to record (e.g., by storing in any format) data associated with each audible object, such as a volume or a frequency of the audible object. The results of the identification operations performed by the audible object identification module 320 may be used by the audible object classification module 322 and other modules and systems discussed herein.

The audible object classification module 322 may be configured to classify multiple types of audible objects included in recorded sounds. In some aspects, the audible object classification module 322 may use the results of the audio analysis module 318 and the audible identification module 320 to classify each audio object recorded. For example, the audible object classification module 322 may be configured to use audible identification data recorded by the audible object identification module 320 to assist in classifying the audible object. The audible object classification module 322 may also perform additional analysis of the image to further assist in classifying the audible object.

The classification of an audible object may include a variety of factors, such as a frequency or a volume of the audible object and the like. For example, a particular audible object may be identified as a voice by the audible object identification module 320. The audible object classification module 322 may further classify the voice as that of a person that is male, female, young, or old, and the like. Other audible objects may have different classification factors based on the characteristics associated with the particular type of object. The results of the audible object classification operations performed by the audible object classification module 322 may be used by one or more other modules and systems discussed herein.

The audio processing subsystem 302 may further include an audible activity identification module 324. The audible activity identification module 324 may be configured to perform a variety of operations related to identifying one or more activities in a particular recording. For example, the audible activity identification module 324 may be configured to identify an activity associated with multiple audible objects in a recording. In some aspects, the audible activity identification module 324 may identify that a kitchen appliance is generating a warning sound while a smoke alarm is also sounding an alarm, or the audible activity identification module 324 may identify that the dog 256 is barking and that someone is pressing the doorbell on the doorbell camera 214 (see FIG. 2).

The type of identified audible activity determined by the audible activity identification module 324 may depend on the type of audible object (e.g., based on the object classification performed by the audible object classification module 322). The results of the audible activity identification operations performed by the audible activity identification module 324 may be used by one or more other modules and systems described herein.

The audio query module 326 may be configured to analyze queries, such as spoken natural language queries from a user. In some aspects, the queries may request information related objects or activities in one or more images. For example, a natural language query from a user may pertain to sounds or other audio objects, such as, “Can you turn off that sound?” The audio query module 326 can analyze the received query to determine the specified object or activity, then analyze audio objects to identify the sounds in which the user is interested. In some implementations, the audio query module 326 may use information generated by one or more of the audio analysis module 318, the audible object identification module 320, the audible object classification module 322, and the audible activity identification module 324. The results of the query analysis operations performed by the audio query module 326 may be used by one or more other modules and systems described herein.

The audio search module 328 may be configured to identify various types of objects or activities in one or more recordings. In some aspects, the audio search module 328 may be configured to work in combination with the audio query module 326 to identify sounds that satisfy a user's natural language query. In some implementations, the audio search module 328 may use information generated by one or more of the audio analysis module 318, the audible object identification module 320, the audible object classification module 322, the audible activity identification module 324, and the audio query module 326. The results of the search operations performed by the audio search module 328 may be used by one or more other modules and systems discussed herein.

In aspects, the metadata module 116 also includes the historical interaction analysis subsystem 304 to access the metadata 118 (see FIG. 1) to access requests and commands previously entered by the user or other users. When the user or other users submit requests or commands, records of the requests and commands are stored in the metadata 118 based on a rationale that, if the user or users previously were interested in a particular function of the facility management system 100, the user or users may later be interested in those same functions. Accordingly, when the user submits a request and the facility management system 100 seeks to determine what the user may want, the historical interaction analysis system 304 may assist in identifying potentially relevant suggestions and/or may help to disambiguate between multiple possible, relevant suggestions by comparing a current request to previous requests and/or commands presented by the user.

Thus, the metadata module 116 is configured to provide context for a user request to the facility management system 100. By analogy, in conversation with another person, it may be helpful to understand what that other person is asking or trying to tell you to understand what is happening around them or what types of things they have discussed previously. In other words, often when presented in conversation with an unexpected request, it is not unusual to ask that person, “Why are you asking?” The metadata module 116, rather than inquiring of the user “Why are you asking?” to try to clarify a request from a user, the metadata module 116 looks at the visual, audible, and/or historical context for the request to ascertain why the user might be asking and, as a result, be better able to provide one or more relevant suggestions to respond to the request.

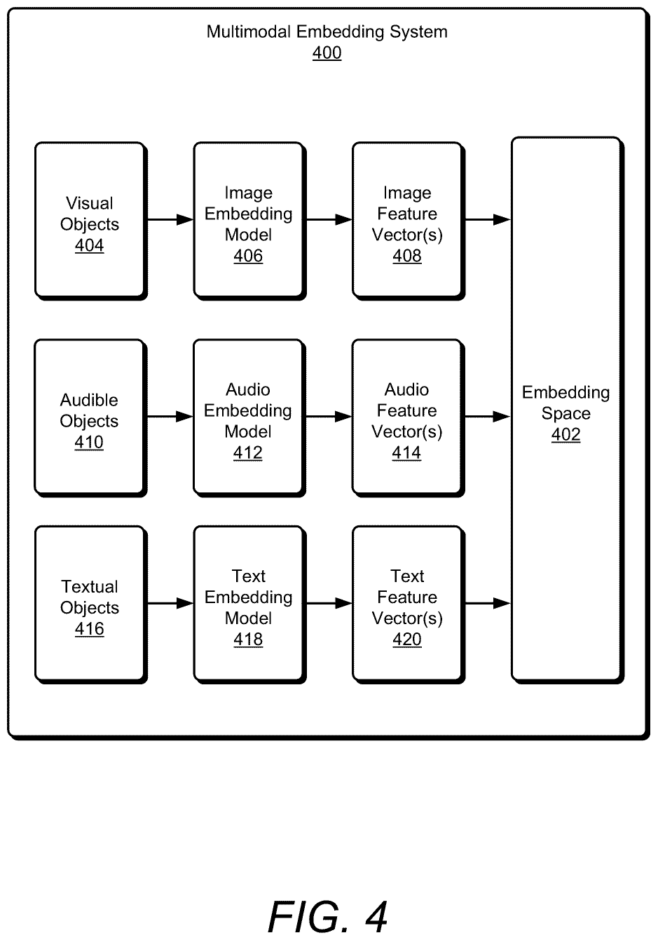

FIG. 4 shows a multimodal embedding system 400 that may be used to build or to augment the metadata 116 (see FIG. 1) based on a body of images or videos of visual objects, sounds or other audible objects, and text objects such as might be presented in a textual user request. In aspects, the metadata 116 includes an embedding space 402 that includes vectorized representations of image/videos or other visual objects, sounds or other audible objects, and textual objects to form a contextual memory of the facility management system 100 that is embodied in the metadata 116. The embedding space 402 may include separate spaces for vectorized representations of each of the visual objects, audible objects, and textual objects, or vectorized representations of visual objects, audible objects, and textual objects may be mapped to the same embedding space. It will be appreciated that the use of the term “vectors” or “vectorized,” as understood in the art, refers to the numeric representation of different objects that may be used in image, sound, and text recognition systems. The numeric vector representations make the visual or audible data indexable for access by available search tools from the embedding space 402 to enable computing systems to store, analyze, and compare visual, audible, and/or textual objects to support plain language search of such data in response to requests as well as the generation of plain language responses to such requests. It is appreciated that the term multimodal embedding system 400 signifies the capacity of the embedding space 402 to accommodate different modes of represented data, including visual, audible, and/or textual objects. It also is appreciated that the metadata 116 may be generated by processes other than or in addition to embedding of visual, audible, and/or textual objects, and that the multimodal embedding system 400 is only one example of how the contextual metadata 116 may be generated.

The multimodal embedding system 400 may receive one or more visual objects 404, such as images and/or videos, which are captured, for example, by one or more image capture devices such as the cameras 214, 216, 224, and 240 (see FIG. 2). The visual objects 404 are provided to an image embedding model 406, which generates one or more image feature vectors 408 based on frames of visual data included in the images and/or videos included in the visual objects 404. In aspects, the image feature vectors 408 may be large numeric representations that identify various aspects of frames of the visual objects 404. The resulting image feature vectors 408 are then mapped to the embedding space 402 to which incoming visual objects may be compared to find matches to provide a context for preparing suggestions in response to a user request.

Correspondingly, the multimodal embedding system 400 may receive one or more audible objects 410 that are captured, for example, by one or more microphones or other audio capture devices such as the smart speakers 222 and 238. The audible objects 410 are provided to an audio embedding model 412, which generates one or more audio feature vectors 414 based on the audible objects 410 presented. In aspects, the audio feature vectors 414, like the image feature vectors 408, may be large numeric representations that identify various aspects of the one or more audible objects 410. The resulting audio feature vectors 414 are then mapped to the embedding space 402.

Finally, the multimodal embedding system 400 may receive one or more textual objects 416 that may be presented by one or more users via a control device such as the control panel 246 or another text-enabled control device such as a computer or smartphone in communication with the facility management system 100. The textual objects 416 are provided to a text embedding model 418 which generates one or more text feature vectors 420 based on the textual objects 416 presented that result in text feature vectors 420 that are mapped to the embedding space 402 like the image feature vectors 408 and the audio feature vectors 414. By matching newly received visual, audible, and/or textual inputs with the vectors 408, 414, and 420 mapped to the embedding space 402 of the multimodal embedding system, the personalized suggestion manager 102 is able to identify metadata that corresponds with the inputs to present relevant suggestions and responses to the user.

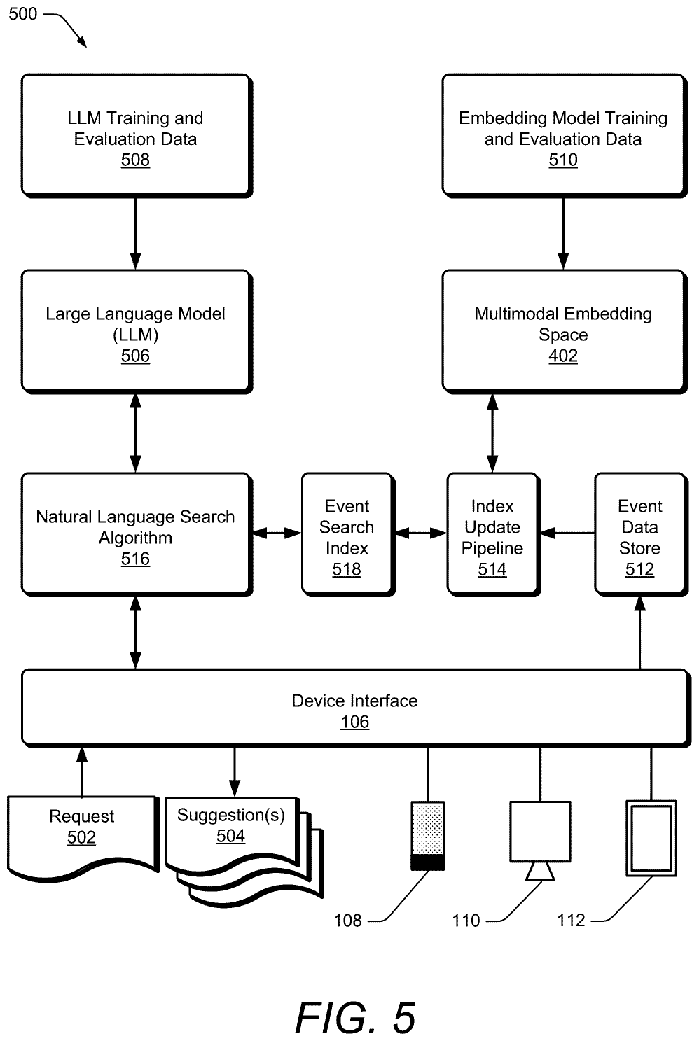

FIG. 5 illustrates an example of a suggestion system 500 that uses the LLM module 120 and the embedding space 402 to respond to a request 502 from a user and to present one or more suggestions 504 for actions the user may choose based on the content and the context of the request 502. The request 502 may be received via the device interface 106 from a device such as the smart speaker 108, the camera 110, and/or the computing device 112 described with reference to FIG. 1. The natural language processing system 500 includes a large language model (LLM) 506 to analyze large amounts of data and learn various patterns between the data elements, such as patterns or connections between words, phrases, images, and the like. In some aspects, the LLM 506 may, in response to one or more prompts, identify relevant information about the content or context of the request 502 and generate the one or more suggestions 504 based on the content or context of the request 502.

The LLM 506 incorporates user data collected and processed within the facility management system 100 (see FIG. 1) with LLM training and evaluation data 508 that provides a foundation for the LLM 506. The LLM training and evaluation data 508 may include real world data, simulated data, synthetic data, and the like that provides a foundation for the LLM 506. Thus, in aspects, the LLM 506 is pre-trained on a variety of visual, audible, and/or textual data, then is further trained based on user input and data gathered in the user's facility. In aspects, the LLM training and evaluation data 508 may be continually updated based on feedback from users, administrators, other systems, and the like to adjust responses of the LLM training and evaluation data 504 which then is propagated through the LLM 506 to enhance the function of the LLM 506. For example, if a user provides negative feedback about a response of the LLM 506 and it is determined that it is because of shortcomings or other issues with the LLM training and evaluation data 508, an administrator or other person may re-create the user query and identify a correct response and modify the LLM training and evaluation data 508. An updated version of the LLM training and evaluation data 508 may then be applied to the LLM 506 to correct the identified deficiencies.

The multimodal embedding space 402 described with reference to FIG. 4 includes data from embedding model training and evaluation data 510. Analogous to how the LLM evaluation and training data 508 provides a foundation for the LLM 506 to support natural language processing, the embedding model training and evaluation data 510 provides a foundation for the multimodal embedding space 402 that maintains the image feature vectors 406, audio feature vectors 414, and/or text feature vectors 420 generated by the multimodal embedding system 400 (see FIG. 4).

In addition to receiving the request 502 via the device interface 106, the natural language processing system 500 may receive additional data about the context of the request 502 from the device interface 106 via one or more input devices including audio, video, and/or text inputs such as the smart speaker 108, the camera 110, and/or the computing device 112. The data captured by the input devices 108, 110, and/or 112 may be received and maintained in an event data store 512. The data stored in the event data store 512 represents the context of a request received from the user by representing visual objects the user may be seeing, audible objects the user may be hearing, or other contextual details that may be related to the request 502. Just as a person reading a document may be able to interpret a word or phrase based on the context provided by the surrounding text or a person evaluating an element of a situation may be able to discern information about that element from the surrounding scene and/or attendant circumstances, the event data store 512 maintains a context in which a user request may be interpreted.

An index update pipeline 514 is configured to receive data from the event data store 512 and to perform various operations related to indexing data used by the natural language processing system 500. For example, the data received by the event data store 512 may be vectorized like the image embedding model 406, the audio embedding model 412, and the text embedding model 418 vectorize respective types of data. Using the data received from the event data store 512, the index update pipeline 514 is able to act on input from an event search index 518 to find similar or corresponding metadata in the multimodal embedding space 402 that may relate to the context represented in the event data store 512.

The index update pipeline 514 is also configured to respond to an event search index 518 that is generated by a natural language search algorithm 516 in response to the request 502 received from the user. The natural language search algorithm 516 uses the LLM 506 to parse and process the request 502 which might result in a search of the multimodal embedding space 402, such as when the request may concern an object or event in the facility 200 (see FIG. 2) that is managed by the facility management system 100. The event search index 518 may include terms that are presented to the index update pipeline 514 which the index update pipeline 514 may then vectorize and present to the multimodal embedding space 402 to find contextual information. Referring again to the previous examples of requests such as “Who came to the door this morning?” or “Can you turn off that sound?” to the index update pipeline 514 to retrieve relevant data stored in the multimodal embedding space 402. In turn, any relevant data found is returned to the event search index 518 and to the natural language search algorithm 516 where the retrieved metadata may be encapsulated with text and presented as one of the one or more suggestions 504 responsive to the request 502.

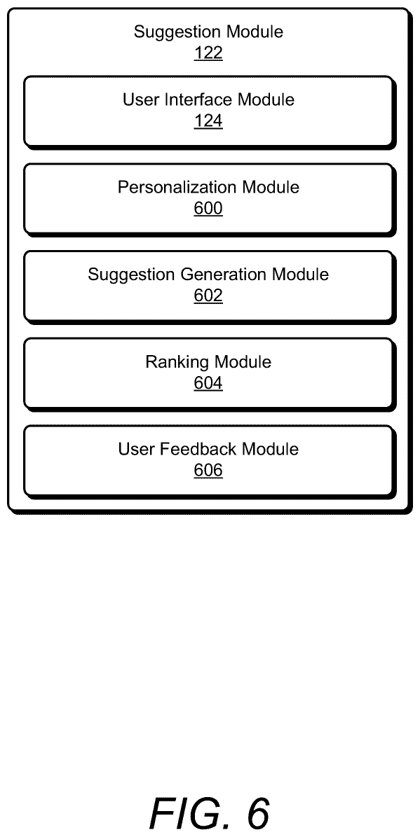

FIG. 6 illustrates an example diagram of the suggestion module 122 of the personalized suggestion manager 102 (see FIG. 1). In aspects, the personalized suggestion management system includes the user interface module 124, a personalization module 600, a suggestion generation module 602, a ranking module 604, and a user feedback module 606. The user interface module 124 may be configured to allow one or more users to interact with the personalized suggestion manager 102 via natural language verbally with a smart speaker such as smart speaker 108, by using a physical keyboard or a touchscreen-based virtual keyboard of the computing device 112, or by another form of user input. As previously described with reference to FIG. 1, the user interface module 124 may inform the user of available actions or operations that may be performed in response to the user's request instead of or in addition to the facility management system 100 causing the action or operation to be performed without seeking confirmation or selection by the user. Voice or text interaction with the user interface module 124 may be supported by a device integrated with or dedicated to the facility management system 100, such as the control panel 246 (see FIG. 2) of the facility management system 100 or may include some other device, such as a mobile telephone (not shown in FIG. 6), in communication with the facility management system 100. The user interface module 124 may be configured to allow a user to select from multiple suggestions presented by the personalized suggestion manager 102, as described in the foregoing examples.

The personalization module 600 may be configured to identify or generate one or more prompts or queries for the user in response to a request based on the context, which may include visual or auditory awareness of the user's surroundings, commonly invoked or previously invoked user commands, previous user queries, the available devices in the facility 200 (see FIG. 2), and the like. In some aspects, the personalization module 600 may personalize a response of the suggestion module 122 based on recognition of the user making the request by using the video processing subsystem 300 or the audio processing subsystem 302 or other systems. The personalization module 600 may be in communication with the suggestion generation module 602 so as to personalize the suggestions by name, language, tone, or other aspects based on available information about the user.

The suggestion generation module 602 is configured to generate one or more suggestions for the user based on personalization information received from the personalization module 600 and/or other information about the request prompting the suggestion as described with reference to FIG. 5 and further described below. With information about the user and other aspects of the context of the request, the suggestion generation module 602 may be configured to generate one or more suggestions or prompts determined to be relevant to the request as presented in context.

The ranking module 604 can rank multiple suggestions or prompts based on the likelihood that they are appropriate for the request relative to the context. For example, the ranking module 604 may rank multiple personalized suggestions generated by the suggestion generation module 602 and present the highest-ranked suggestions (e.g., the top three or top five suggestions) to the user for possible selection. The ranked suggestions may be presented to the user via the user interface 124 in textual form to a display screen of the control panel 246 or another computing device in the facility 200 (see FIG. 2). Alternatively, the ranked suggestions may be presented to the user via the user interface 124 in audio form through an audio device included in the control panel 246, another computing device, one of the smart speakers 222 and 238, or another device.

In some aspects, the natural language search algorithm 516 (see FIG. 5) may generate a relevancy score for each of the possible responses based on how closely related the possible responses are related to the content and context of the response. In some aspects, the suggestions may be ranked based on historical data relative to other previously presented requests according to how relevant the past suggestions were based on whether the user “clicked through” or otherwise selected a similar response with an audiovisual or other type of interface device. The relevance may be based in part on a count and relevance of other suggestions presented. For example, if the suggestion generation module 602 generates three suggestions, but the relevancy score for the first suggestion is much greater than others, only one suggestion may be offered. On the other hand, if many suggestions are presented that are reasonably close in relevancy score, the suggestion generation module may present the top responses up to a default number indicated by user preference or a predetermined parameter.

The user feedback module 606 receives feedback from the user regarding the one or more suggestions presented by the suggestion generation module 602. For example, if the user is prompted to confirm the suggested action, the user feedback module 606 receives the user's confirmation, such as by manual or spoken response, to enable the facility management system 100 to perform the requested action. Alternatively, if the suggestion generation module 604 presents one or more suggestions, the user feedback module 606 may receive the user's selection of one of the suggestions to initiate a suggested action or receive an indication, such as by manual or spoken response, as to which of the suggestions is the most appropriate and, if necessary, to act on the suggestion. When multiple suggestions are presented by the suggestion generation module 602, the user feedback module 606 may record the user's selection of the approved suggestion and the rank of that selection is the highest rank suggestion to confirm that the ranking presented by the ranking module 604 was appropriate. If a lower-ranked suggestion is selected by the user, the user's response to the ranking is presented to the ranking module 604 for use by the ranking module to adapt its ranking process to more accurately present the user's preferred suggestions at the top of the list. Further, if none of the responses is acceptable, by manual or verbal input, the user may indicate to the user feedback module 606 that the suggestions are not appropriate to further inform the suggestion generation module 602 and the ranking module 604 so that both modules 602 and/or 604 may improve the generation and ranking, respectively, of the presented suggestions. The feedback received by the user feedback module 606 may be processed and stored for global improvements to the suggestion generation module 602 and/or may be associated with the user in the personalization module 600 to provide more appropriate suggestions and rankings for the particular user.

### Example Operations of the Personalized Suggestion Manager

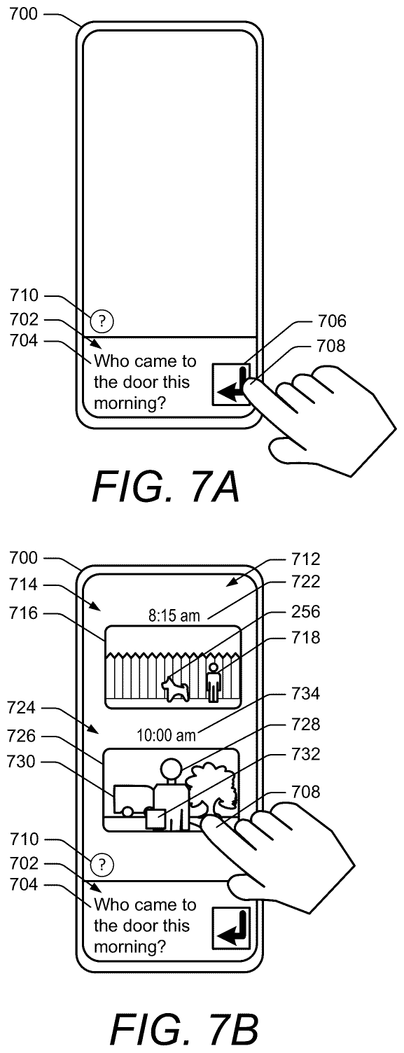

FIGS. 7A and 7B illustrate a user interaction with a smartphone 700 in communication with the facility management system 100 (see FIG. 1) to receive suggestions from the personalized suggestion manager 102. In FIG. 7A, in a text entry field 702, the user presents a request 704 in text form to the personalized suggestion manager 102, asking “Who came to the door this morning?” The query might be submitted by a user engaging an enter or send input 706 with a finger 708. If the user needs help in framing the request 704, the user may engage a help feature by touching a help key 710. The help key 710 may offer step-by-step guidance to the user in what options may be available and what inputs the user can or should provide.

FIG. 7B shows an output of the personalized suggestion manager 102 in response to the request 704. The personalized suggestion manager 102 presents two suggested answers or responses in a response window 712 on the smartphone 700. A first suggestion 714 includes a first thumbnail image 716, which may allow the user to access a video or a larger image of an event that the personalized suggestion manager 102 believes is responsive to the request 704. The thumbnail 716 shows a child 718 playing with the dog 256 presumably outside a backdoor of the facility 200 at a time 722 of 8:15 a.m. (which matches the “this morning” parameter of the request 704). A second suggestion 724 includes a second thumbnail image 726 of another event that the personalized suggestion manager 102 believes is responsive to the request 704. The thumbnail 726 shows a delivery person 728 and a delivery vehicle 730, with the delivery person 728 presenting a package 732 at a time 734 of 10:00 a.m. (which also matches the “this morning” parameter of the request 704), presumably at the front entry 212 of the facility 200.

With the finger 708, the user selects the second suggestion 724. From this selection, the personalized suggestion manager 102 may collect feedback indicating that, when the user refers to “the door” in a request such as “Who came to the door this morning?” the user means the front entry 212 of the facility 200. By being presented with multiple suggestions 714 and 724, the user receives the information or action in which the user is interested and the personalized suggestion manager 102 learns interests or behaviors of the user which may assist the personalized suggestion manager 102 in responding to the next request. For example, if the user was to enter the same request 704 the next day, the personalized suggestion manager 102 may only provide suggestions relating to people appearing at the front entry 212 of the facility 200. In this way, the personalized suggestion manager 102 may thus personalize the suggestions presented to the user making the request.

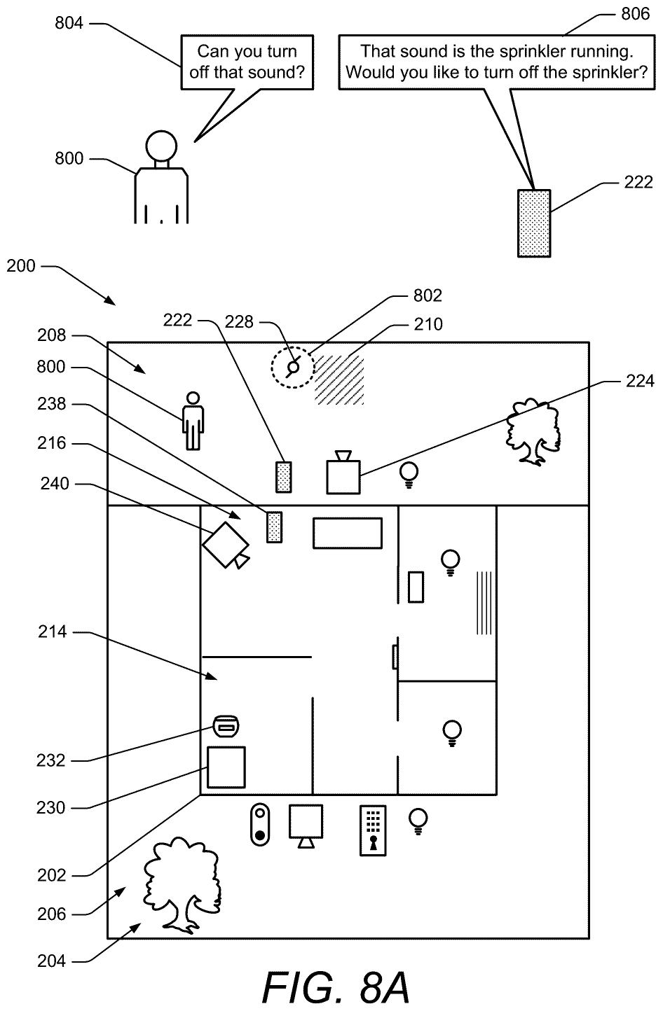

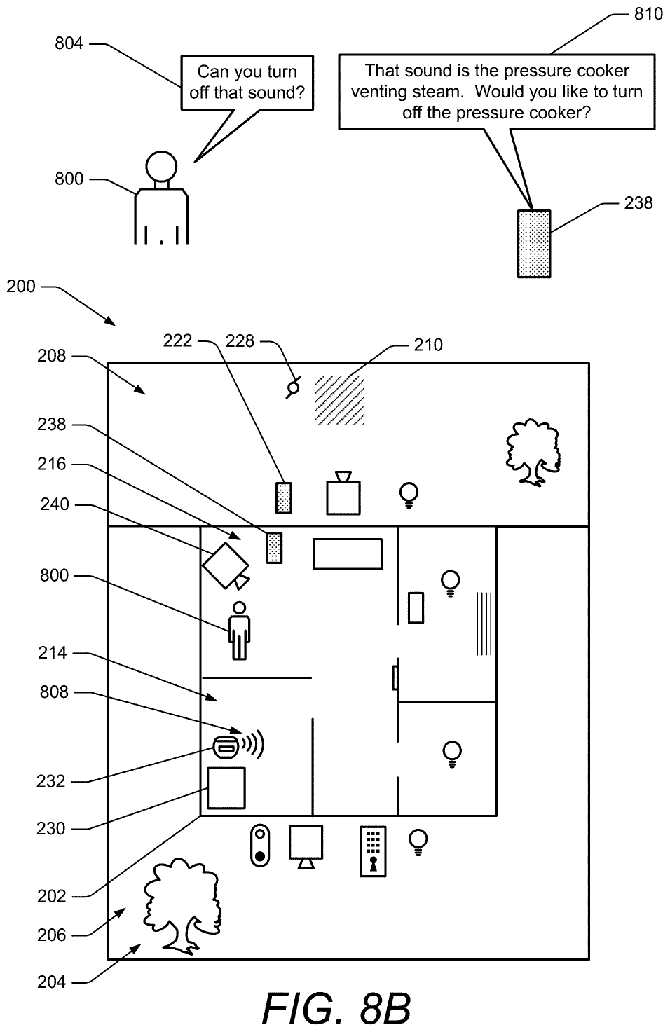

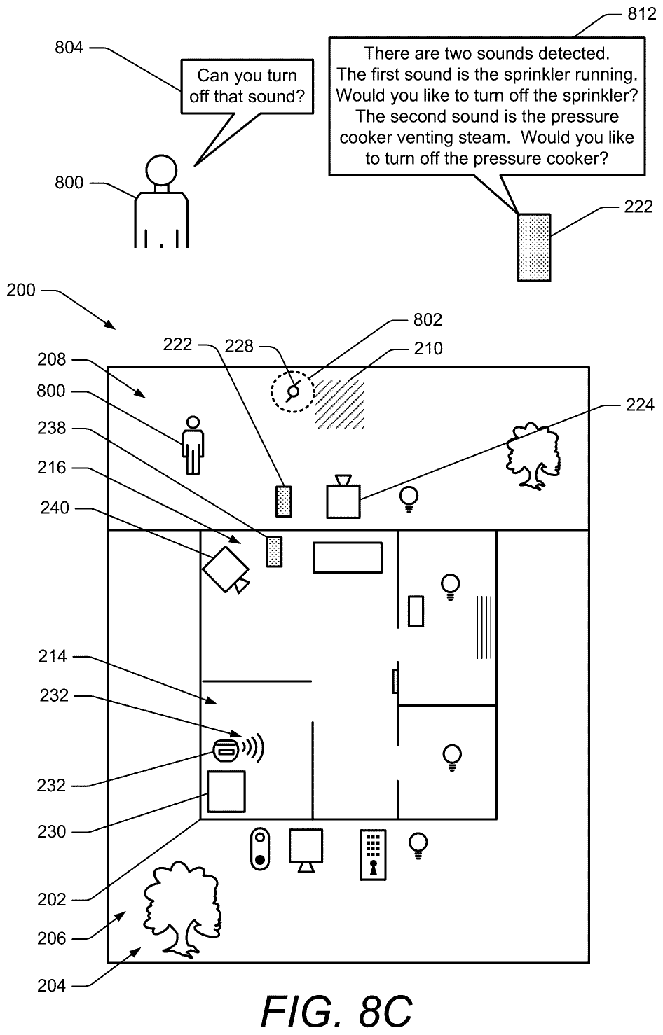

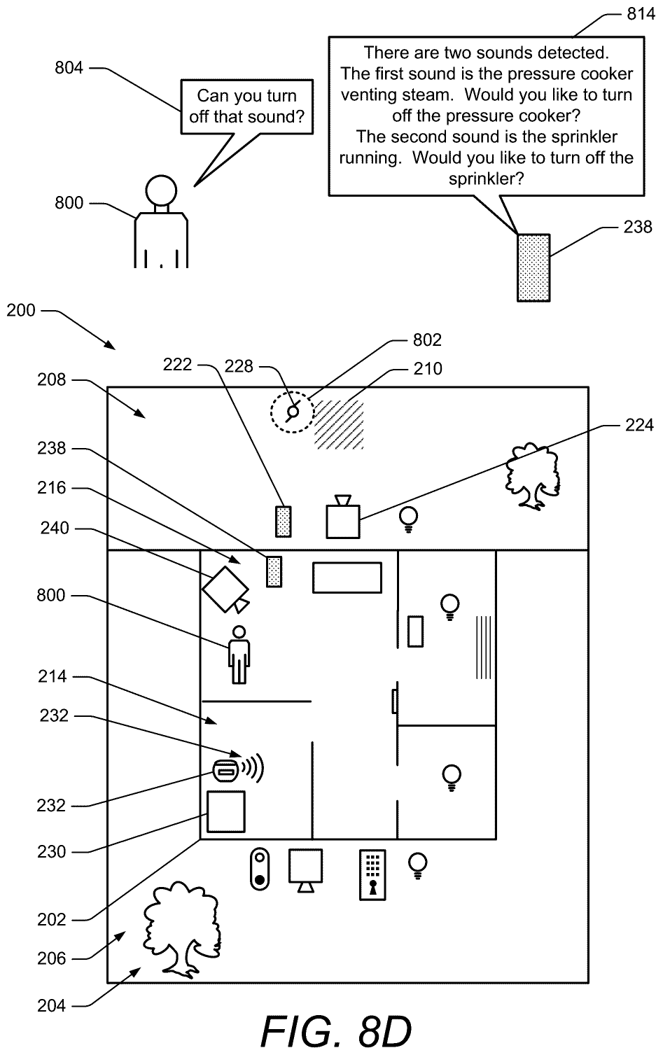

FIGS. 8A-8D depict a user 800 responding to a noise that they hear and asking the facility management system 100 to stop the sound. Depending on the context of the request, the personalized suggestion manager 102 may provide different suggestions to the user 800. Referring to FIG. 8A, the user 800 stands in the backyard 208 of the facility 200. The sprinkler system 228 is running, as represented by the dotted circle 802 representing the sound of spraying water released by the sprinkler system 228. Unsure of the source of a noise the user 800 hears, the user 800 issues a verbal request 804, “Can you turn off that sound?” which may be detected by the smart speaker 222 in the backyard 208. Presumably, the user 800 first issues a wake word or command to signal to the smart speaker 222 to indicate that the user is directing the request 804 to the smart speaker 222.

In this example, the facility management system 100 includes metadata in the embedding space 402 (see FIG. 4), which may have been received from the embedding model training and evaluation data 510, that includes a vectorized representation of a sound made by the sprinkler system 228. Along with receiving the request 804 via the smart speaker 222, the personalized suggestion manager 102 also may detect the sounds heard by the user 800 as part of the context of the request 804. Combining the request 804 and the context of the request in the form of the sound of spraying water 802 and a location of the user 800 (which may be determined by the request 804 being detected by the smart speaker 222 in the backyard 208 or by the camera 224 in the backyard 208), the personalized suggestion manager 102 determines what the “sound” mentioned in the request 804 is. Thus, the personalized suggestion manager 102 offers a suggestion 806 from the smart speaker 222 in the form of a suggested course of action, stating “That sound is the sprinkler running. Would you like to turn off the sprinkler?” The user 800 may choose to respond to accept or reject the suggestion 806 with a further verbal request (not shown in FIG. 8A).

Because the personalized suggestion manager 102 is responsive to both content and context of a request, the user 800 may receive different suggestions depending on the context, as described with reference to FIGS. 8B-8D. Referring to FIG. 8B, the user 800 moves to the family room 216 of the facility 200, hears a sound of steam being released 808 generated by the pressure cooker 232 in the kitchen 214 and presents the same request 804, “Can you turn off that sound?” The content of the request 804 presented in the example FIG. 8B is the same as the request presented in the example of FIG. 8A. However, although the content of the request 804 is the same, the sound 808 heard by the user 800 is different. Therefore, the context of the request 804 is different. Because the personalized suggestion manager 102 is responsive to context in the form of the sound 808, the one or more suggestions generated by the personalized suggestion manager 102 also are different. Combining the request 804 and the context of the request in the form of the sound of the pressure cooker 808, the personalized suggestion manager 102 offers a suggestion 810 from the smart speaker 238, stating “That sound is the pressure cooker venting steam. Would you like to turn off the pressure cooker?” The user 800 may choose to respond to accept or reject the suggestion 810 with a further verbal request (not shown in FIG. 8B).

Referring to FIG. 8C, the user 800 moves back to the backyard 208 of the facility 200 and again poses the request 804, “Can you turn off that sound?” In the example of FIG. 8C, the sound of spraying water released by the sprinkler system 802 and sound of steam being released 808 are both part of the context of the request 804; thus, while the content of the request 804 is again the same, the presence of multiple sounds changes the context of the request 804. As a result, a response 812 of the personalized suggestion manager 102 may include two suggestions and reply that, “There are two sounds detected. The first sound is the sprinkler running. Would you like to turn off the sprinkler? The second sound is the pressure cooker venting steam. Would you like to turn off the pressure cooker?” Because there are multiple sounds, the personalized suggestion manager 102 provides multiple suggestions from which the user 800 can choose the desired action.

Similarly, referring to FIG. 8D, the user 800 moves back to the family room 216 of the facility 200 while both sounds 802 and 808 are present and again poses the request 804, “Can you turn off that sound?” Once again, while the content of the request 804 is again the same, the presence of the multiple sounds 802 and 808 changes the context of the request 804. As a result, a response 814 of the personalized suggestion manager 102 may include two suggestions and reply that, “There are two sounds detected. The first sound is the pressure cooker venting steam. Would you like to turn off the pressure cooker? The second sound is the sprinkler running. Would you like to turn off the sprinkler?” Once again, because there are multiple sounds, the personalized suggestion manager 102 provides multiple suggestions from which the user 800 can choose the desired action.

It will be appreciated that, although the substance of the responses 812 and 814 of the personalized suggestion manager 102 is the generally the same, the order in which the two suggestions are listed is switched: in the response 812, the sound of the sprinkler system spraying water 802 is listed first, while in the response 814, the sound of the pressure cooker releasing steam 808 is listed first. The location of the user 800 is also part of the context of the request. Thus, in the example of FIG. 8C, when the user asks, “Can you turn off that sound?” the personalized suggestion manager 102 receives the request via the smart speaker 222 in the backyard 208 of the facility 200. Based on the relative closer proximity of the user 800 to the sound of the sprinkler system spraying water 802, which may be based on the volume of the request 804 and sound 802 detected by the smart speaker 222 or by the camera 224 detecting the user 800 in the backyard 208, the personalized suggestion manager 102 prioritizes the nearer and/or louder of the sounds 802 and 808, that of the sound of the sprinkler system spraying water 802.

By contrast, in the example of FIG. 8D, when the user asks, “Can you turn off that sound?” the personalized suggestion manager 102 receives the request via the smart speaker 238 in the living room 216 of the facility 200. Based on the relative closer proximity of the user 800 to the sound of the pressure cooker releasing steam 808, which may be based on the position from which the request 804 is made and/or a relative volume of the sounds 802 and 808 detected by the smart speaker 238 or by the camera 240 detecting the user 800 in the family room 216, the personalized suggestion manager 102 prioritizes the nearer and/or louder of the sounds 802 and 808 in the reply 814, that of the sound of the pressure cooker releasing steam 808.

Thus, context of a request determinable from video and/or audio data or from other information available to the personalized suggestion manager 102 may alter the suggestions generated by the personalized suggestion manager 102. It also will be appreciated that, through the use of the LLM 506 (see FIG. 5), the personalized suggestion manager 102 is able to phrase the content of the suggestions to include prefacing remarks for multiple suggestions, such as “There are two sounds detected,” as included in both the responses 812 and 814, as well as using proper syntax in describing the “first sound” and the “second sound” in the responses 812 and 814.

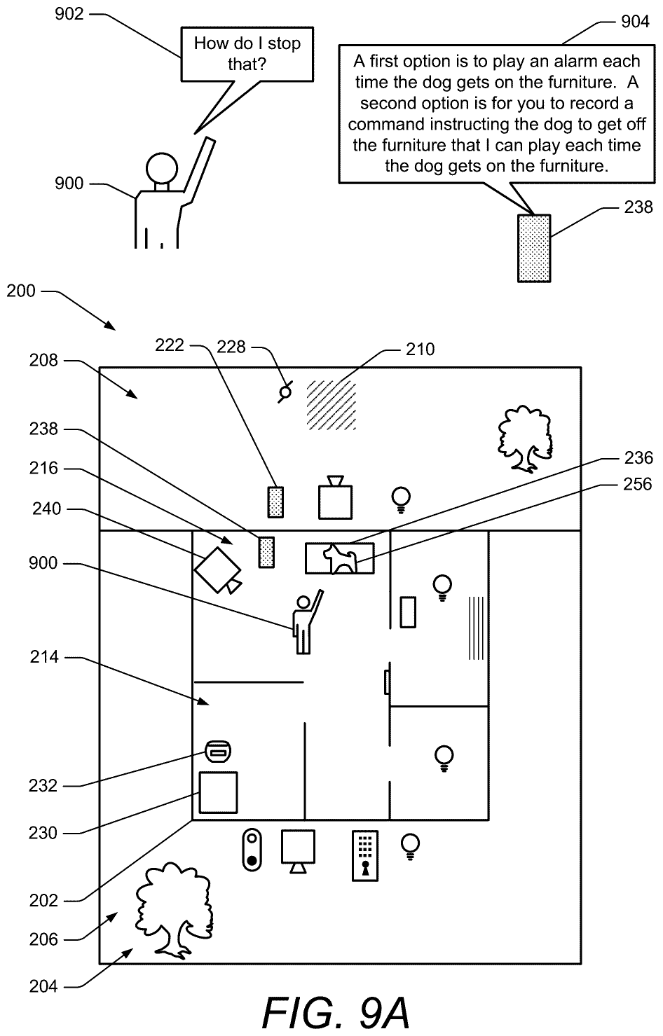

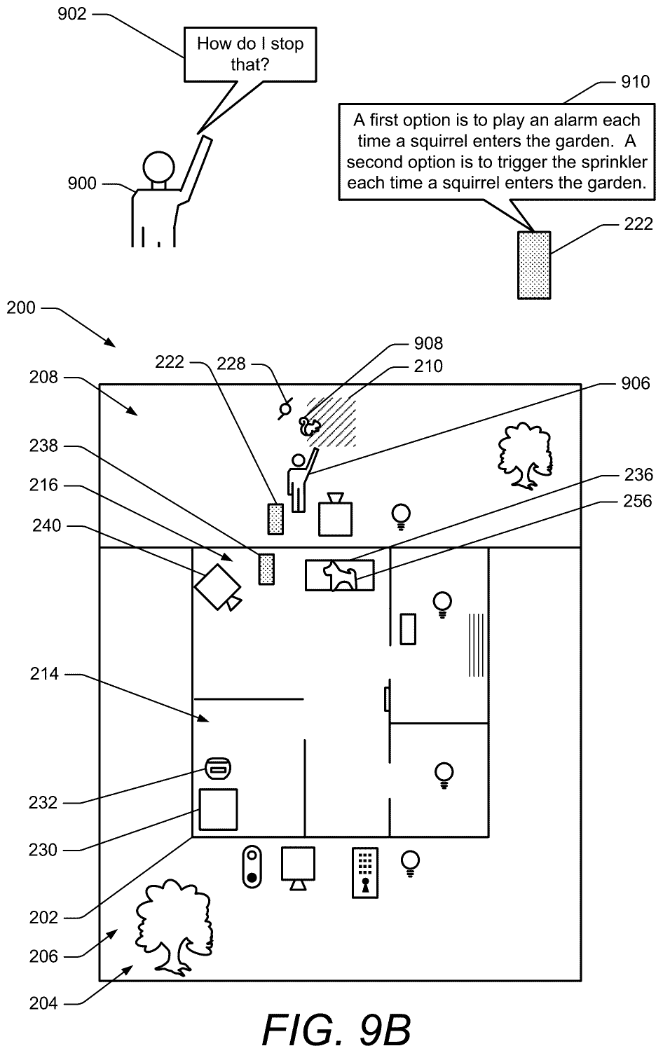

FIGS. 9A and 9B further illustrate how video data of the context may be used by the personalized suggestion manager 102 to respond to a request. Referring to FIG. 9A, a user 900 is in the family room 216 of the facility 200 and pointing at the dog 256 lying on the furniture 236 and presents the request 902, “How do I stop that?” The personalized suggestion manager 102 can determine from the request 902 being received by the smart speaker 238 in the family room 216 where the user 900 is located, but more than the location may be needed to interpret what the user means in posing the request 902, “How do I stop that?” From the user 900 pointing at the dog 256 lying on the furniture 236, from a suitably trained embedding space 402 (see FIG. 2) incorporating robust embedding model training and evaluation data 510 (see FIG. 5), the personalized suggestion manager 102 may be able to interpret the intention of the user 900 by comparing metadata derived from the pointing of the user 900 compared to metadata included in the embedding space 402. Thus, the personalized suggestion manager 102 may discern from the request 902 and the context that the user 900 wants help in keeping the dog 256 off the furniture 236 and offer the suggestion 904, “A first option is to play an alarm each time the dog gets on the furniture. A second option is for you to record a command instructing the dog to get off the furniture that I can play each time the dog gets on the furniture.” The user 900 can respond to the suggestion 904 in order to achieve a desired result.

Referring to FIG. 9B, a user 906 is in the backyard 208 of the facility 200 and pointing at a squirrel 908 in the garden 210 and once again presents the request 902, “How do I stop that?” The personalized suggestion manager 102 can determine from the request 902 being received by the smart speaker 222 in the backyard 208 where the user 906 is located but, as in the example of FIG. 9A, more may be needed to interpret what the user means in posing the request 902, “How do I stop that?” From the user 906 pointing at the squirrel 908 in the garden 210, from a suitably trained embedding space 402 (see FIG. 2) incorporating robust embedding model training and evaluation data 510 (see FIG. 5), the personalized suggestion manager 102 may be able to interpret the intention of the user 906 by comparing metadata derived from the pointing of the user 906 compared to metadata included in the embedding space 402. Thus, the personalized suggestion manager 102 may discern from the request 902 and the context that the user 906 wants help in keeping the squirrel 908 out of the garden 210 and offer the suggestion 910, “A first option is to play an alarm each time a squirrel enters the garden. A second option is to trigger the sprinkler each time a squirrel enters the garden.” The user 900 can respond to the suggestion 904 in order to achieve a desired result. Thus, in different aspects, information about the context, including video data, audio data, location data, and any other type of contextual data may be used by the personalized suggestion manager to respond to a user request.

It will be appreciated that, with the breadth of capabilities of the personalized suggestion manager 102, it may be advantageous for the personalized information manager to provide assistance to a user who may need help to achieve desired results. As previously described with reference to FIG. 7A, a user may be able to manually engage a help key 710 to seek assistance. However, in some aspects, the personalized suggestion manager 102 may be able to respond to the context to automatically offer assistance to a user who may need it.

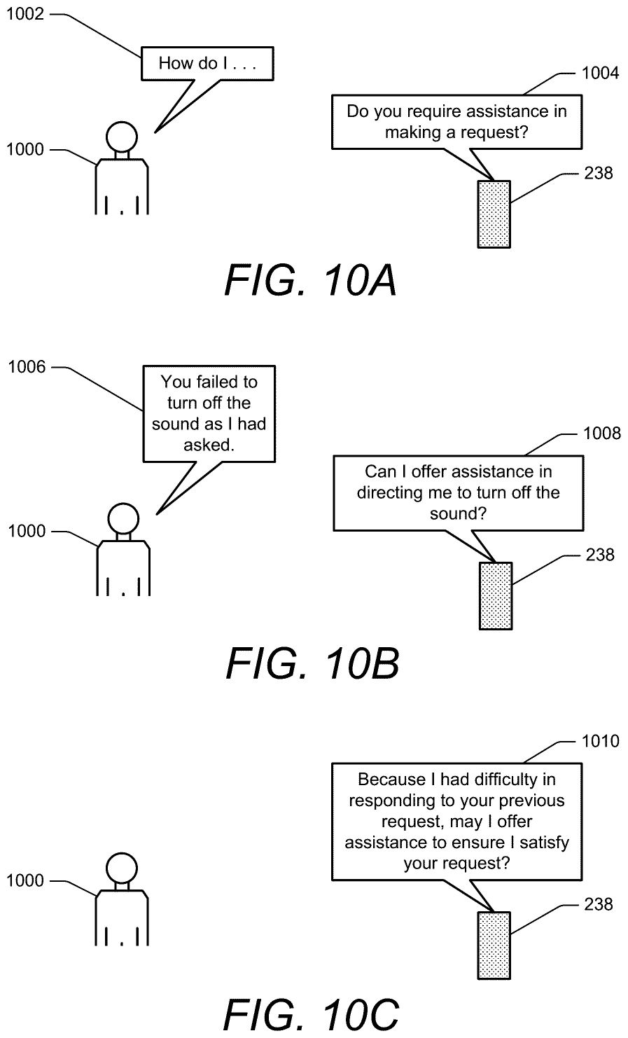

Referring to FIG. 10A, a user 1000 may present a start of a request 1002, stating “How do I . . . ” Because of the delay in completing the request after beginning the request, the personalized suggestion manager 102 may determine that the user 1000 requires assistance. Accordingly, the personalized suggestion manager may offer a response 1004 from the smart speaker 238 (or other device receiving the start of the request 1002), “Do you require assistance in making a request?” With further prompts, the personalized suggestion manager 102 may thus be able to aid the user 1000 in completing an intended request and/or performing a desired action.

Referring to FIG. 10B, the personalized suggestion manager 102 also may be able to provide assistance in response to the user 1000 providing a negative exclamation or reply to a previous response or action from the personalized suggestion manager, such as by the user making a user reaction 1006, “You failed to turn off the sound as I had asked.” In response to the statement 1006, the personalized suggestion manager 102 may offer a response 1008 conformed to the content of the statement, “Can I offer assistance in directing me to turn off the sound?” The personalized suggestion manager 102 may then be able to prompt or lead the user 1000 to accomplish a desired result.

Also, referring to FIG. 10C, after a series of actions not being successfully completed, perhaps as signified by multiple negative statements from the user 1000, such as the statement 1006, the personalized suggestion manager 102 may determine from historical search data, which may be provided by the historical interaction analysis subsystem 304 of the metadata module 116 (see FIG. 3), an inability of the user 1000 to secure a desired action. In response, the personalized suggestion manager 102 may initiate an offer of help: “Because I had difficulty in responding to your previous request, may I offer assistance to ensure I satisfy your request?” The context of a particular user's historical difficulty in directing the personalized suggestion manager 102 to achieve results may aid the personalized suggestion manager 102 in being able to preemptively offer assistance to the user 1000.

### Example Computer Systems for Use With the Personalized Suggestion Manager

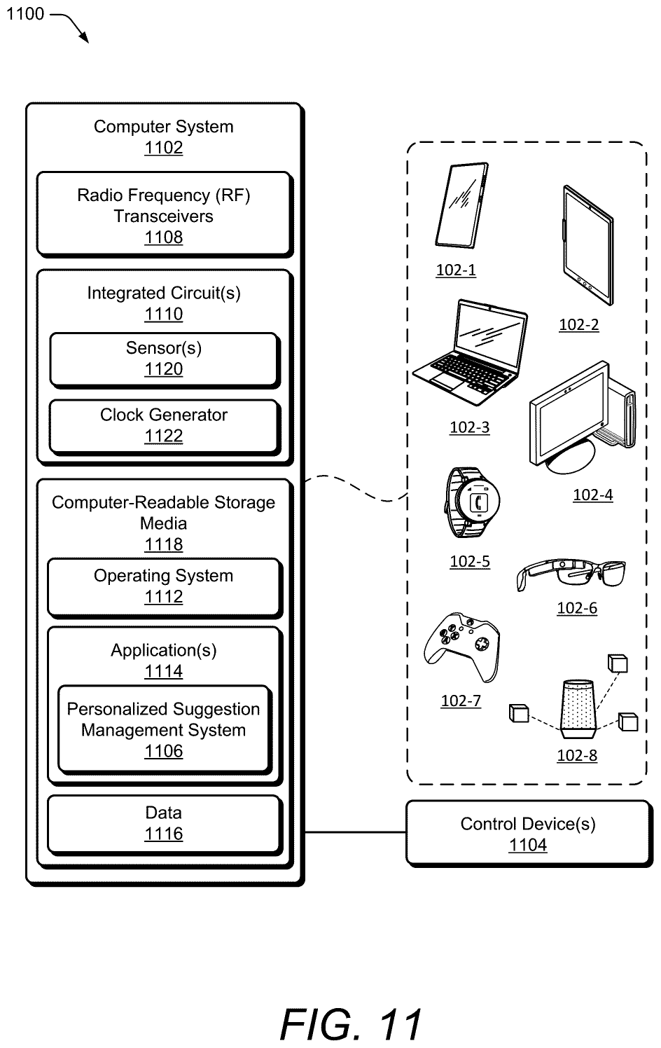

FIG. 11 illustrates a block diagram of a facility management system 1100 that includes a computer system 1102 to assist a user in engaging the facility management system 1100 to perform functions to manage operation of one or more control devices 1104 associated with the facility management system 1100. As previously described, the control devices 1104 may include remotely controllable devices such as lights 220, 224, 242, 248, and 252, audio output devices 222 and 238, the sprinkler system 228, the appliances 230, 232, and 234, and/or other devices in communication with the facility management system 100 (see FIG. 1) that may communicate via a device interface 106 as described with reference to FIG. 1.

The computer system 1102 is an example of a system in which the facility management system 1100 with a personalized suggestion management system 1106 can be implemented. The computer system 1102 may include additional components and interfaces omitted from FIG. 1 for the sake of clarity. The computer system 1102 may include a variety of consumer electronic devices. As non-limiting examples, the computer system 1102 may include a mobile phone 1102-1, a tablet device 1102-2, a laptop computer 1102-3, a desktop computer 1102-4, a computerized watch 1102-5, a wearable computer 1102-6, a video game controller 1102-7, a voice-assistant system 1102-8, and/or other computer systems.

The computer system 1102 may include one or more radio frequency (RF) transceivers 1108 for communicating over wireless networks. In aspects, the computer system 1102 is operable to tune the one or more RF transceivers 1108 and supporting circuitry (e.g., antennas, front-end modules, amplifiers) to one or more frequency bands defined by various communication standards.

The computer system 1102 may include one or more integrated circuits 1110. The one or more integrated circuits 1110 may include, as non-limiting examples, a central processing unit, a graphics processing unit, or a tensor processing unit. A central processing unit generally executes commands and processes needed for the computer system 1102, an operating system 1112, one or more application programs 1114 including the personalized suggestion management system 1106, and data 1116 (which may include data and metadata) that may be stored in and/or executed from computer-readable storage media 1118. The integrated circuits 1110 may include a graphics processing unit that performs operations to display graphics of the computer system 1102 and can perform other specific computational tasks. The integrated circuits 1110 may include a tensor processing unit that generally performs symbolic match operations in neural-network machine-learning applications. The integrated circuits 1110 may include single-core or multiple-core processors. The computer-readable storage media 1118 may include any suitable storage device including, for example, random-access memory (RAM), static RAM (SRAM), dynamic RAM (DRAM), non-volatile RAM (NVRAM), read-only memory (ROM), Flash memory, and/or other storage devices

The one or more integrated circuits 1110 may include one or more sensors 1120 and a clock generator 1122. The integrated circuits 1110 can include other components (not illustrated), including communication units (e.g., modems), input/output controllers, and system interfaces. The one or more sensors 1110 also may include sensors or other circuitry operably coupled to at least one integrated circuit 1110 to monitor the process, voltage, and temperature of the integrated circuits 1110 to assist in evaluating operating conditions of the one or more integrated circuits 1110. The sensors 1120 can also monitor other aspects and states of the integrated circuits 1110. The integrated circuits 1110 may be configured to utilize outputs of the sensors 1120 to monitor a state, including a state of the one or more integrated circuits 1110 themselves. Other modules can also use the sensor outputs to adjust the system voltage of the one or more integrated circuits 1110.

The clock generator 1122 provides an input clock signal, which can oscillate between a high state and a low state, to synchronize operations of the one or more integrated circuits 1110. In other words, the input clock signal can pace sequential processes of the one or more integrated circuits 1110. The clock generator 1122 can include a variety of devices, including a crystal oscillator or a voltage-controlled oscillator, to produce the input clock signal with a consistent number of pulses to regulate clock cycles of the integrated circuits 1110 according to a particular duty cycle (e.g., the width of individual high states) at the desired frequency. As an example, the input clock signal may be a periodic square wave.

The personal suggestion management system 1106 includes modules such as those described with reference to FIGS. 1, 3, 4, 5, and 6 configured to execute on the computer system 1102 to use content and context of a request to provide suggestions to a user.

### Example Method of Personal Suggestion Management

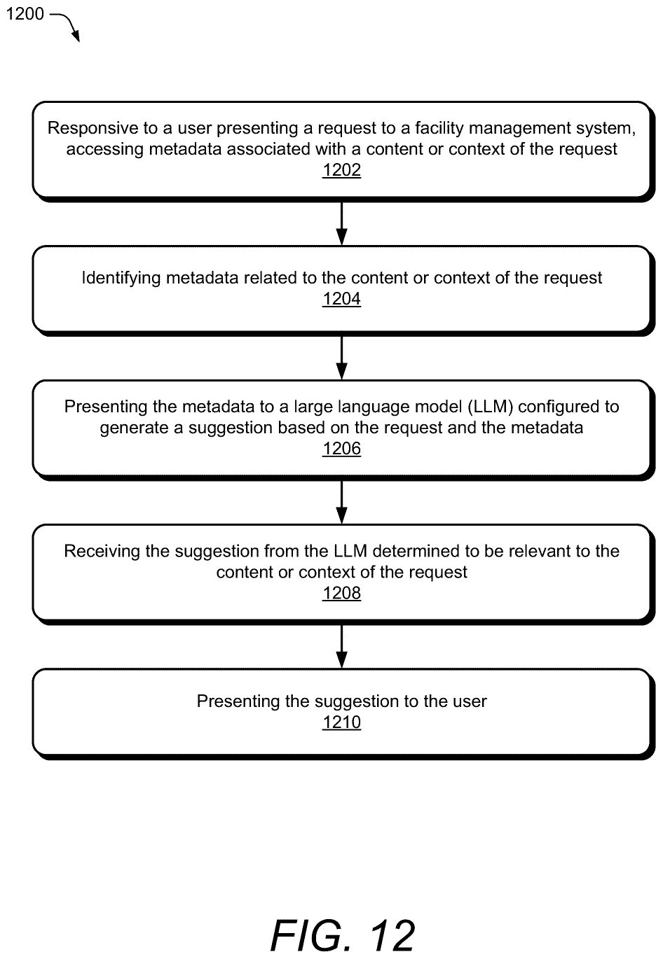

FIG. 12 is a flow diagram illustrating an example method 1200 for generating one or more personalized suggestions in response to a request received from a user. In some implementations, the method 1200 may be performed by one or more of the modules contained in the personalized suggestion manager 102 which may be implemented on one of the computer systems 1100 described with reference to FIG. 11.

At a block 1202, responsive to a user presenting a request to a facility management system, metadata associated with one of a content or context of the request is accessed. As described with reference to FIGS. 3-5, the content of the request, whether in textual and/or or audio form, and the context of the request, which may include video, audio, and/or textual data may be vectorized for comparison to the metadata in the multimodal embedding space. At a block 1204, metadata related to one of the content or context of the request is identified. As described with reference to FIG. 5, for example, the index update pipeline 514 may receive the content and context data and search for analogous content in the multimodal embedding space 402. At a block 1206, the metadata is presented to a large language model (LLM) configured to generate a suggestion based on the request and the metadata. For example, by using a natural language search algorithm 516, one or more suitable suggestions relevant to the request and its context may be presented by the LLM 506.

At a block 1208, the suggestion from the LLM determined to be relevant to the content or context of the request is generated, such as exemplified with reference to FIGS. 7A, 7B, 8A-8D, 9A, and 9B. At a block 1210, the suggestion is presented to the user. As previously described, once presented to the user, the user may choose to accept the suggestion or choose from among multiple suggestions for action by one of the control devices of the facility management system 100.

This document describes systems and techniques for implementing personalized suggestions for a user interacting with a facility management system based on contextual metadata to assist the user in controlling the facility management system.

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c, or any other ordering of a, b, and c). Further, items represented in the accompanying figures and terms discussed herein may be indicative of one or more items or terms, and thus reference may be made interchangeably to single or plural forms of the items and terms in this written description.

Further to the descriptions above, a user may be provided with controls allowing the user to make an election as to both if and when systems, programs, or features described herein may enable collection of user information (e.g., information about a user's social network, social actions, social activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (for example, to a city, ZIP code, or state level), so that a particular location of a user cannot be determined. Thus, the user may have control over what information is collected about the user, how that information is used, and what information is provided to the user.

### Conclusion

Although various configurations of systems and methods for implementing personalized suggestions for a user interacting with a facility management system based on contextual metadata to assist the user in controlling the facility management system have been described in language specific to features and/or methods, it is to be understood that the subject of the appended claims is not necessarily limited to the specific features or methods described. Rather, the specific features and methods are disclosed as non-limiting examples of implementing personalized suggestions.

What is claimed is:

1. A method comprising:
responsive to a user presenting a request to a facility management system, accessing metadata associated with a content or context of the request;
identifying metadata related to the content or context of the request;
presenting the metadata to a large language model (LLM) configured to generate a suggestion based on the request and the metadata;
receiving the suggestion from the LLM determined to be relevant to the content or context of the request; and
presenting the suggestion to the user.

2. The method of claim 1, wherein the suggestion includes:
a suggested answer; or
a suggested course of action.

3. The method of claim 1, further comprising determining that the user requires assistance in submitting the request by detecting:
an engaging of a help function;
a delay in completing the request for longer than a specified interval of time after beginning the request;
an indication that a previous response of the facility management system was unsatisfactory; or
a history of interaction with the facility management system indicative of an inability of the user to secure a desired action.

4. The method of claim 1, wherein the context of the request includes visual or audible data associated with the user or a facility associated with the facility management system, the facility including a home, business, yard, activity, device owned, hobby, pet, or other individual associated with the user.

5. The method of claim 4, wherein the visual or audible data associated with the user are maintained in a multimodal embedding model indexable for access by a natural language search algorithm associated with the LLM.

6. The method of claim 1, wherein the context of the request includes historical search data including a previous request from the user and a user reaction to a previous suggestion or action by the facility management system.

7. The method of claim 1, further comprising:
ranking multiple suggestions according to a relative relevance of each of the multiple suggestions; and
presenting the multiple suggestions to the user in an order according to the ranking.

8. The method of claim 7, further comprising collecting feedback to the one or more suggestions indicative of relevancy of the one or more of the suggestions.

9. A system comprising:
a request module configured to receive a request to a facility management system and from a user;
a metadata module configured to access and identify metadata related to a content or context of the request;
a large language model (LLM) module configured to receive the request and the metadata and to generate a suggestion relevant to one of the content or context of the request; and
a suggestion module configured to present the suggestion to the user.

10. The system of claim 9, wherein the suggestion includes:
a suggested answer; or
a suggested course of action.

11. The system of claim 9, wherein the request module is configured to determine that the user requires assistance, by detecting:
an engagement a help function;
a delay in completing the request for longer than a specified interval of time after beginning the request;
an indication that a previous response of the facility management system was unsatisfactory; or
a history of interaction with the facility management system indicative of an inability of the user to secure a desired action.

12. The system of claim 9, wherein the context of the request includes visual or audible data associated with the user or a facility associated with the facility management system, the facility including a home, business, yard, activity, device owned, hobby, pet, or other individual associated with the user.

13. The system of claim 12, wherein the visual or audible data associated with the user are maintained in a multimodal embedding model indexable for access by a natural language search algorithm associated with the LLM.

14. The system of claim 9, wherein the context of the request includes historical search data including a previous request from the user and a user reaction to a previous suggestion or action by the facility management system.

15. The system of claim 9, further comprising a ranking module configured to:
rank multiple suggestions according to a relevance of each of the multiple suggestions; and
present the multiple suggestions to the user via the suggestion module in an order according to the ranking.

16. The system of claim 15, further comprising a feedback module configured to collect feedback to the multiple suggestions indicative of relevancy of each of the multiple suggestions.

17. A system for facility management comprising:
one or more input devices configured to collect data and receive a user request;
one or more control devices configured to respond to instructions based on the user request; and
a device interface configured to receive the user request from the one or more input devices;
a personalized suggestion manager including:
a request module configured to determine that the user requires assistance in submitting the request;
a metadata module configured to access and identify metadata related to a content or context of the request;
a large language model (LLM) module configured to generate, based on the request and the metadata, a suggestion relevant to the content or context of the request; and
a suggestion module configured to present the suggestion to the user.

18. The system of claim 17, wherein the context of the request includes visual or audible data associated with the user or a facility, the facility including a home, business, yard, activity, device owned, hobby, pet, or other individual associated with the user.

19. The system of claim 18, wherein the visual or audible data associated with the user are maintained in a multimodal embedding model indexable for access by a natural language search algorithm associated with the LLM.

20. The system of claim 17, wherein the context of the request includes historical search data including a previous request from the user and a user reaction to previous suggestion or action by the facility management system.
